(19) United States
(12) Patent Application Publication
(10) Pub. No.: US 2023/0131606 A1
(43) Pub. Date: Apr. 27, 2023

(54) HEADLINER AND DISTRIBUTION SYSTEM

(71) Applicant: ABC TECHNOLOGIES INC., Toronto (CA)

(72) Inventor: Richard ALLAN, Holland Landing (CA)

(21) Appl. No.: 17/910,918

(22) PCT Filed: Mar. 11, 2021
(86) PCT No.: PCT/CA2021/050330

§ 371 Date: Sep. 12, 2022

Related U.S. Application Data
(60) Provisional application No. 62/989,066, filed on Mar. 13, 2020.

(51) Int. Cl. B60H 1/34; B60R 13/02; B60H 1/24

(52) U.S. Cl. CPC B60H 1/3407; B60R 13/0212; B60H 1/245

(57) ABSTRACT

Provided is a headliner air distribution system. The system includes a headliner assembly having a lower perforated sheet that is stationary, and an upper perforated sheet that is moveable relative to the first perforated sheet. The headliner assembly is supported upon an underside surface of a vehicle roof by a pair of bracket rails. The arrangement of the bracket rails serves to place the headliner assembly in spaced-apart relationship relative to the underside surface of the vehicle roof, to establish a plenum for receiving HVAC air. The spatial arrangement of the upper perforated sheet relative to the lower perforated sheet is used to control the passage of HVAC air from the plenum through the headliner assembly into the passenger compartment.

### FIELD OF THE INVENTION

The present invention relates to the provision of HVAC air in motor vehicles, and in particular to a system of distributing HVAC air through a headliner of a motor vehicle.

### BACKGROUND OF THE INVENTION

The passenger compartment of an automobile is in the process of being re-envisioned, in particular as the industry moves towards autonomous and semi-autonomous vehicles. While the automobile passenger compartment was once a strictly utilitarian construct, it is progressively becoming an extension of personal living space. Accordingly, the comfort of occupants within this space is paramount, especially as automobiles integrate into a broader range of consumer interests and activities.

The distribution of climate-controlled air within the passenger compartment has typically employed the use of vents positioned at various locations around the passenger compartment, such as the instrument panel, within front and rear foot wells, as well as the center console. While this arrangement of vents has been effective for the traditional layout of a vehicles interior, the move towards autonomous vehicles has the potential to reshape this traditional arrangement, necessitating improvements in the manner by which climate-controlled air is distributed within the passenger compartment.

### SUMMARY OF THE INVENTION

According to an aspect of an embodiment, provided is a headliner air distribution system. The system includes a headliner assembly having a lower perforated sheet that is stationary, and an upper perforated sheet that is moveable relative to the first perforated sheet. The headliner assembly is supported upon an underside surface of a vehicle roof by a pair of bracket rails. The arrangement of the bracket rails serves to place the headliner assembly in spaced-apart relationship relative to the underside surface of the vehicle roof, to establish a plenum for receiving HVAC air. The spatial arrangement of the upper perforated sheet relative to the lower perforated sheet is used to control the passage of HVAC air from the plenum through the headliner assembly into the passenger compartment.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a partial sectional view of a prior art headliner assembly of a vehicle.

FIG. 2 is a partial sectional view of a headliner assembly in accordance with an embodiment of the invention.

FIG. 3 shows the upper and lower perforated sheets in isolation, to highlight the hole patterns provided in each.

FIGS. 4a to 4c illustrate a first embodiment of the headliner assembly, configured for linear motion between a first position, and a second position.

FIGS. 5a to 5c illustrate a second embodiment of the headliner assembly, configured for linear motion between a first position, and a second position.

FIGS. 6a to 6d illustrate a third embodiment of the headliner assembly, configured for rotary or circular motion between a first position and a fourth position.

FIGS. 7a to 7c illustrate a fourth embodiment of the headliner assembly, configured with a split upper perforated sheet.

### DESCRIPTION OF PREFERRED EMBODIMENT

Specific embodiments of the present invention will now be described with reference to the figures. The following detailed description is merely exemplary in nature and is not intended to limit the invention or the application and uses of the invention. A person skilled in the relevant art will recognize that other configurations and arrangements can be used without departing from the scope of the invention. Furthermore, there is no intention to be bound by any expressed or implied theory presented in the preceding technical field, background, brief summary or the following detailed description.

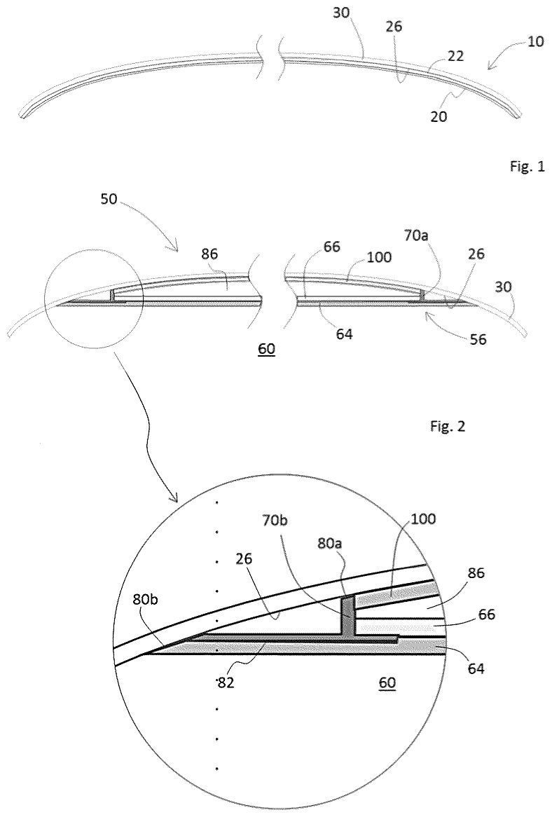

Referring now to FIG. 1, shown is a conventional prior art headliner 10 as typically found on an inside roof surface of a passenger compartment of a motor vehicle. The headliner 10 typically includes an aesthetic layer 20 laminated to a backing layer 22. An exemplary aesthetic layer 20 may be formed of polyester fabric, while an exemplary backing layer 22 may be formed of a polyurethane open cell foam. The headliner 10 is generally affixed using a suitable adhesive to an underside surface 26 of the roof 30 of the vehicle passenger compartment. In this arrangement, the headliner 10 does not provide and/or permit for any defined distribution of HVAC air therethrough.

With reference now to FIG. 2, shown is a headliner air distribution system 50 according to an embodiment of the invention. The headliner system includes a headliner assembly 56 that defines an upper cabin roof structure of the passenger compartment 60. The headliner assembly 56 includes a pair of perforated sheets, including a self-supporting lower perforated sheet 64 that is stationary, and an upper perforated sheet 66 that is moveable relative to the first perforated sheet 64. The headliner assembly 56 is supported upon an underside surface 26 of the vehicle roof 30 by a pair of bracket rails, identified as a first bracket rail 70a and a second bracket rail 70b (collectively referred to as bracket rails 70). The bracket rails 70 each include at least one attachment surface 80 that is configured to receive a suitable adhesive or fastener to fixedly attach the bracket rails 70 upon the underside surface 26. As shown, each of the bracket rails 70 include a pair of attachment surfaces, identified as 80a, 80b. The bracket rails 70 may also include a support surface 82 that is configured to support the mounting of the lower perforated sheet 64. The lower perforated sheet 64 may additionally include an aesthetic layer and a backing layer (not shown), similar to that shown in FIG. 1, with the exception that the additional aesthetic and backing layers are configured to be porous, to permit for the passage of air therethrough.

The arrangement of the bracket rails 70 serves to place the headliner assembly 56 in spaced-apart relationship relative to the underside surface 26 of the vehicle roof 30. In this way, a plenum 86 is established to permit for air distribution in a defined zone above the passenger compartment 60. The air distributed through the plenum 86 is HVAC air, the characteristic (i.e. temperature) of which is adjusted in accordance with the preferences set by the vehicle passengers. Accordingly, the plenum 86 is in fluid communication with the HVAC system of the vehicle. The delivery of HVAC air into the plenum 86 may be achieved in a number of ways, but generally it will be through one or more of the vehicle structural pillars. For example, the HVAC air may be delivered to the plenum 86 through one or both of the structural A and B pillars.

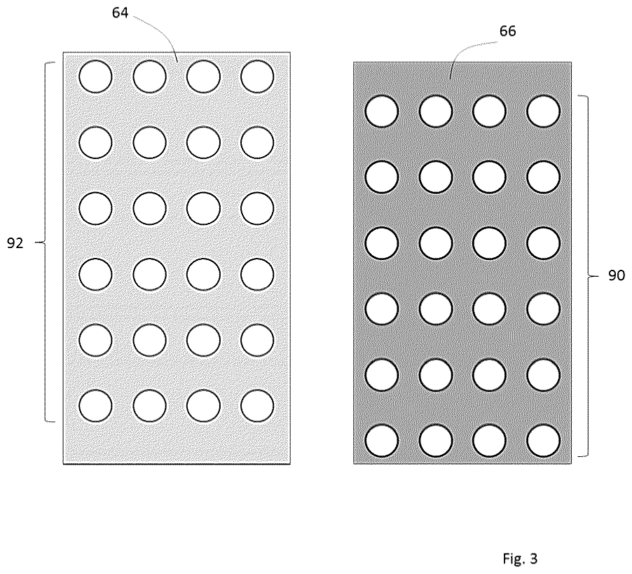

The headliner assembly 56 is configured to be porous, to permit for the passage of HVAC air therethrough, from the plenum 86 into the passenger compartment 60. To permit for control of the air distribution, the spatial arrangement of the upper and lower perforated sheets 66, 64 is used to control the passage of HVAC air. With reference now to FIG. 3, the upper and lower perforated sheets 66, 64 are shown in isolation, and each are shown to include a pattern of holes. In particular, the upper perforated sheet 66 includes a first hole pattern 90, while the lower perforated sheet 64 includes a second hole pattern 92. As the upper perforated sheet 66 is moveable relative to the lower perforated sheet 64, the alignment of the first hole pattern 90 relative to the second hole pattern 92 can be altered, to permit for a desired air-passage opening where the first and second hole patterns 90, 92 overlap.

### Equal XY Pattern

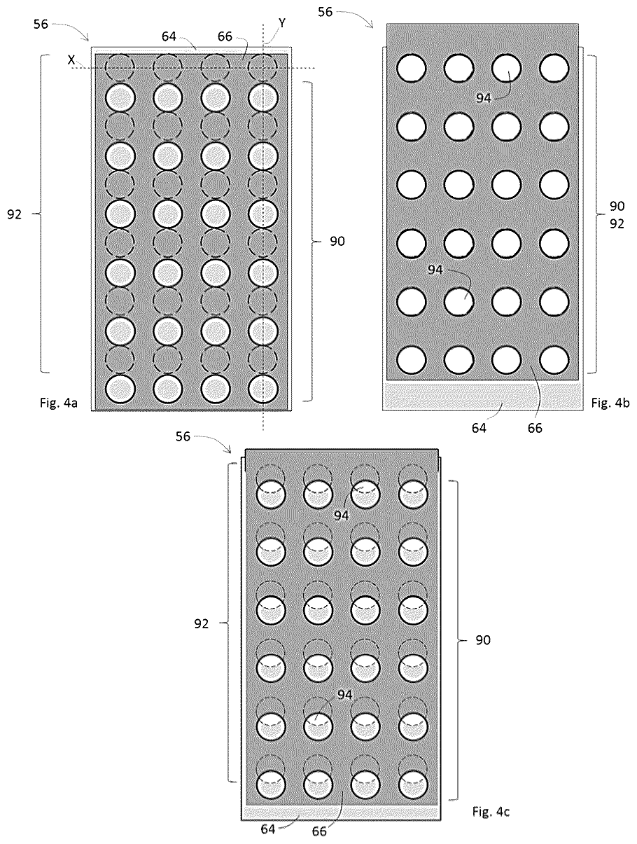

In some embodiments, for example as shown in FIGS. 4a to 4c, the first hole pattern 90 and the second hole pattern 92 may be dimensionally equivalent along both the x-axis (denoted as X) and the y-axis (denoted as Y). In this configuration, the totality of air-passage openings 94 established by the overlap between the first and second hole patterns 90, 92 adjust simultaneously, to provide an equivalent sizing of the openings over the entire headliner assembly 56. For example, in a first position of the moveable upper perforated sheet 66 (as shown in FIG. 4a), there is no overlap between the first hole pattern 90 of the upper perforated sheet 66 and the second hole pattern 92 of the lower perforated sheet 64. In this position, there are no air passage openings established, therein establishing a ‘fully closed’ state that serves to prevent the release of HVAC air from the plenum into the passenger compartment. Upon moving the upper perforated sheet 66 relative to the lower perforated sheet 64 to a second position (as shown in FIG. 4b), a full overlap between the first hole pattern 90 of the upper perforated sheet 66 and the second hole pattern 92 of the lower perforated sheet 64 is established. In this position, each instance of overlap between the first and second hole patterns 90, 92 establishes equally sized air passage openings 94, which in the arrangement shown in FIG. 4b is said to be in a ‘fully opened’ state.

At any intermediate point between the first and second positions, each instance of partial overlap between the first and second hole patterns 90, 92 establishes equally sized partial air passage openings 94, as shown in FIG. 4c. Based on the above, it will be appreciated that the extent of air passage from the plenum 86 through the porous headliner assembly 56 into the passenger compartment 60 can be controlled by the positioning of the moveable upper perforated sheet 66 relative to the stationary lower perforated sheet 64, between the first and second positions, including intermediate positions therebetween.

### Dissimilar Along One Axis

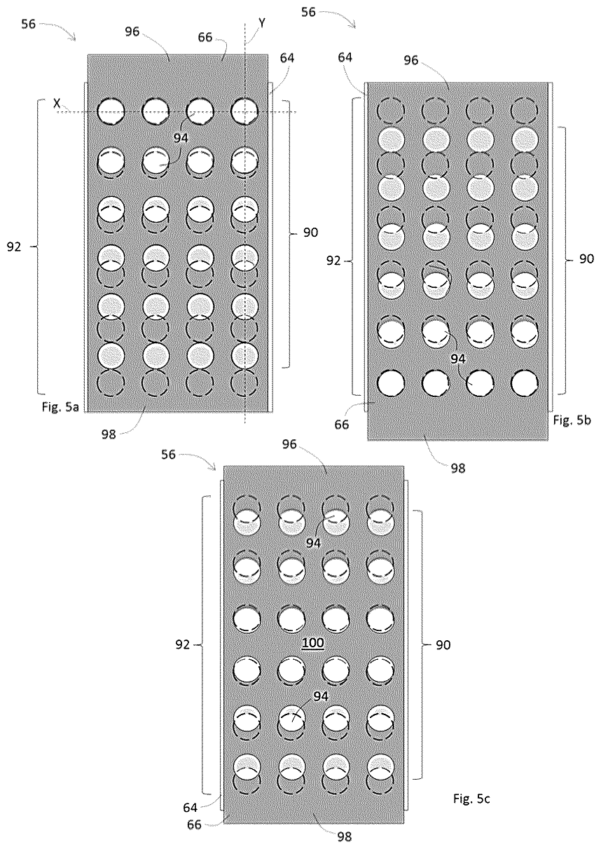

In another embodiment, for example as shown in FIGS. 5a to 5c, the first hole pattern 90 and the second hole pattern 92 may be dimensionally dissimilar along one of the axes, that is either the x-axis (denoted as X) or the y-axis (denoted as Y). As shown, the hole patterns differ along the Y-axis. In this configuration, the plurality of air-passage openings 94 along the y-axis established by the overlap between the first and second hole patterns 90, 92 include a variance in sizing during motion of the upper perforated sheet 66 relative to the lower perforated sheet 64. For example, with reference to FIG. 5a, the upper perforated sheet 66 is shown in a first position, where the overlap between the first and second hole patterns 90, 92 of the respective upper and lower perforated sheets 66, 64 define a plurality of fully opened air passage openings 94 in a first region (or end) 96 of the headliner assembly 56. At the same time at the opposite end of the headliner assembly 56, herein referred to as a second region 98, the arrangement of the first and second hole patterns 90, 92 is such that no air passage openings 94 are established, therein establishing a ‘fully closed’ state in the second region 98. Each row of overlapping (or partially overlapping) hole patterns extending from the first region 96 to the second region 98 become more progressively closed. Accordingly, in the first position as shown in FIG. 5a, the headliner assembly 56 permits for greatest HVAC air flow in the first region 96, with a progressively decreasing amount of air flow along the headliner assembly 56, until a full closure or cessation of headliner air flow in the second region 98.

With reference to FIG. 5b, the upper perforated sheet 66 is shown in a second position. It will be appreciated that in the second position, a similar but opposite arrangement of openings is established in the headliner assembly 56. Specifically, in the second position, the overlap between the first and second hole patterns 90, 92 of the respective upper and lower perforated sheets 66, 64 define a plurality of fully opened air passage openings 94 in the second region 98 of the headliner assembly 56. At the same time in the first region 96 of the headliner assembly 56, the arrangement of the first and second hole patterns 90, 92 is such that no air passage openings are established, therein establishing a “fully closed” state in the first region 96. Each row of overlapping (or partially overlapping) hole patterns extending from the second region 98 to the first region 96 become more progressively closed. Accordingly, in the second position as shown in FIG. 5b, the headliner assembly 56 permits for greatest HVAC air flow in the second region 98, with a progressively decreasing amount of air flow along the headliner assembly 56, until a full closure or cessation of headliner air flow in the first region 96.

The transition from the first position to the second position has the effect of shifting the fully opened air passage openings 94 towards the second region 98. To demonstrate this, with reference to FIG. 5c, the headliner assembly 56 is shown with the upper perforated sheet 66 at an intermediate mid-point between the first and second positions. In this intermediate position, the first and second hole patterns 90, 92 fully overlap in a mid region 100 of the headliner assembly 56, with the first and second regions 96, 98 including only partially opened air passage openings 94. Accordingly, this arrangement, the headliner assembly 56 is said to be ‘fully opened’ in the mid-region 100.

### Dissimilar Along Both Axes

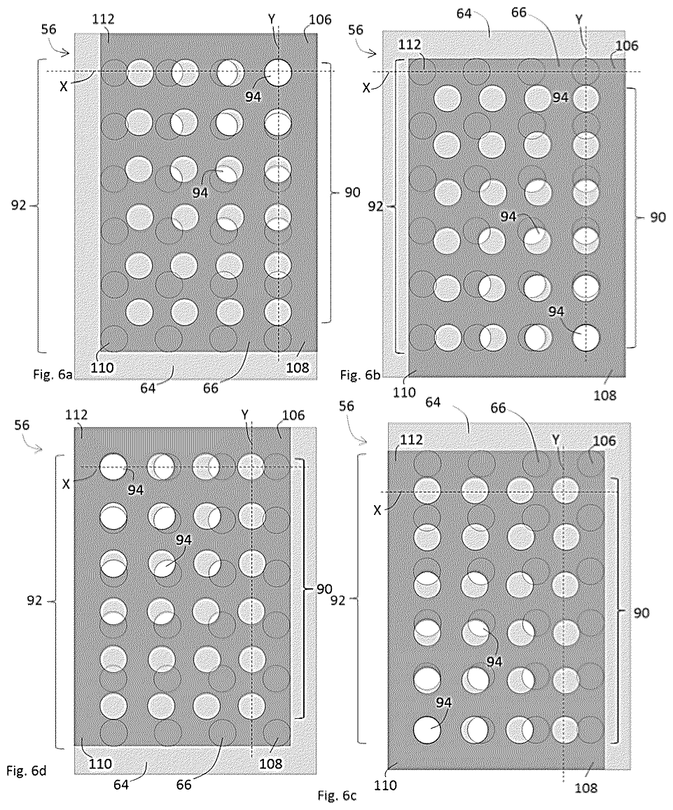

In another embodiment, for example as shown in FIGS. 6a to 6d, the first hole pattern 90 and the second hole pattern 92 may be dimensionally dissimilar along both the x-axis (denoted as X) and the y-axis (denoted as Y). In this configuration, the plurality of air-passage openings 94 along both the x-axis and y-axis established by the overlap between the first and second hole patterns 90, 92 include a variance in sizing during motion of the upper perforated sheet 66 relative to the lower perforated sheet 64. For example, with reference to FIG. 6a, the upper perforated sheet 66 is shown in a first position, where the overlap between the first and second hole patterns 90, 92 of the respective upper and lower perforated sheets 66, 64 define a plurality of air passage openings 94 in a first quadrant 106 of the headliner assembly 56. Within this first quadrant 106, there is one air passage opening 94 (shown at top right), that is fully opened, with the remainder of the air passage openings 94 in the first quadrant 106 being at least partially opened. At the same time in the remaining quadrants (namely the second quadrant 108, the third quadrant 110 and the fourth quadrant 112 of the headliner assembly 56), the arrangement of the first and second hole patterns 90, 92 is such that the plurality of air passage openings 94 are either closed or only partially opened. Accordingly, with the upper perforated sheet 66 in the first position as shown in FIG. 6a, the total area of air passage openings 94 is greatest in the first quadrant 106. In this way, HVAC air flow from the plenum will be predominantly from the first quadrant 106, with lesser or no HVAC air coming from the remaining second, third and fourth quadrants 108, 110, 112.

With reference to FIG. 6b, the upper perforated sheet 66 is shown in a second position. It will be appreciated that in the second position, a similar but shifted arrangement of openings is established in the headliner assembly 56. Specifically, in the second position, the overlap between the first and second hole patterns 90, 92 of the respective upper and lower perforated sheets 66, 64 define a plurality of air passage openings 94 in the second quadrant 108 of the headliner assembly 56. Within this second quadrant 108, there is one air passage opening 94 (shown at bottom right), that is fully opened, with the remainder of the air passage openings 94 in the second quadrant 108 being at least partially opened. At the same time in the remaining quadrants (namely the first quadrant 106, the third quadrant 110 and the fourth quadrant 112 of the headliner assembly 56), the arrangement of the first and second hole patterns 90, 92 is such that the plurality of air passage openings 94 are either closed or only partially opened. Accordingly, with the upper perforated sheet 66 in the second position as shown in FIG. 6b, the total area of air passage openings 94 is greatest in the second quadrant 108. In this way, HVAC air flow from the plenum will be predominantly from the second quadrant 108, with lesser or no HVAC air coming from the remaining first, third and fourth quadrants 106, 110, 112.

With reference to FIG. 6c, the upper perforated sheet 66 is shown in a third position. It will be appreciated that in the third position, a similar but shifted arrangement of openings is established in the headliner assembly 56. Specifically, in the third position, the overlap between the first and second hole patterns 90, 92 of the respective upper and lower perforated sheets 66, 64 define a plurality of air passage openings 94 in a third quadrant 110 of the headliner assembly 56.

Within this third quadrant 110, there is one air passage opening 94 (shown at bottom left), that is fully opened, with the remainder of the air passage openings 94 in the third quadrant 110 being at least partially opened. At the same time in the remaining quadrants (namely the first quadrant 106, the second quadrant 108 and the fourth quadrant 112 of the headliner assembly 56), the arrangement of the first and second hole patterns 90, 92 is such that the plurality of air passage openings 94 are either closed or only partially opened. Accordingly, with the upper perforated sheet 66 in the third position as shown in FIG. 6c, the total area of air passage openings 94 is greatest in the third quadrant 110. In this way, HVAC air flow from the plenum will be predominantly from the third quadrant 110, with lesser or no HVAC air coming from the remaining first, second and fourth quadrants 106, 108, 112.

With reference to FIG. 6d, the upper perforated sheet 66 is shown in a fourth position. It will be appreciated that in the fourth position, a similar but shifted arrangement of openings is established in the headliner assembly 56. Specifically, in the fourth position, the overlap between the first and second hole patterns 90, 92 of the respective upper and lower perforated sheets 66, 64 define a plurality of air passage openings 94 in a fourth quadrant 112 of the headliner assembly 56. Within this fourth quadrant 112, there is one air passage opening 94 (shown at top left), that is fully opened, with the remainder of the air passage openings 94 in the fourth quadrant 112 being at least partially opened. At the same time in the remaining quadrants (namely the first quadrant 106, the second quadrant 108 and the third quadrant 110 of the headliner assembly 56), the arrangement of the first and second hole patterns 90, 92 is such that the plurality of air passage openings 94 are either closed or only partially opened. Accordingly, with the upper perforated sheet 66 in the fourth position as shown in FIG. 6d, the total area of air passage openings 94 is greatest in the fourth quadrant 112. In this way, HVAC air flow from the plenum will be predominantly from the fourth quadrant 112, with lesser or no HVAC air coming from the remaining first, second and third quadrants 106, 108, 110.

It will be appreciated that the transition from the first position through to the fourth position has the effect of shifting the fully opened or substantially opened air passage openings 94 through the various quadrants.

### Split Sheets—Dissimilar Along One Axis

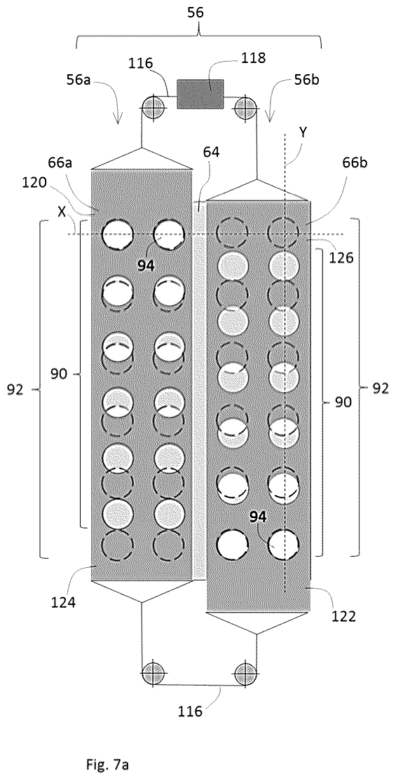

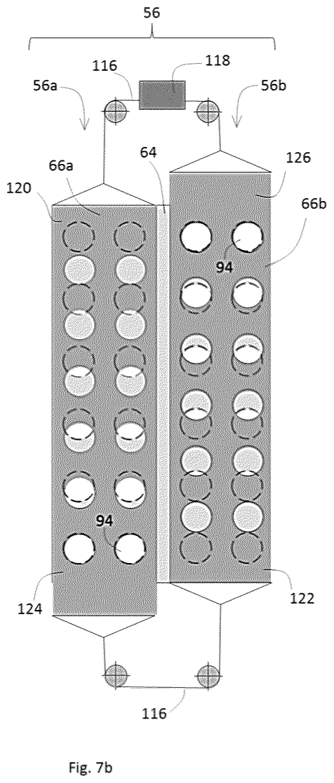

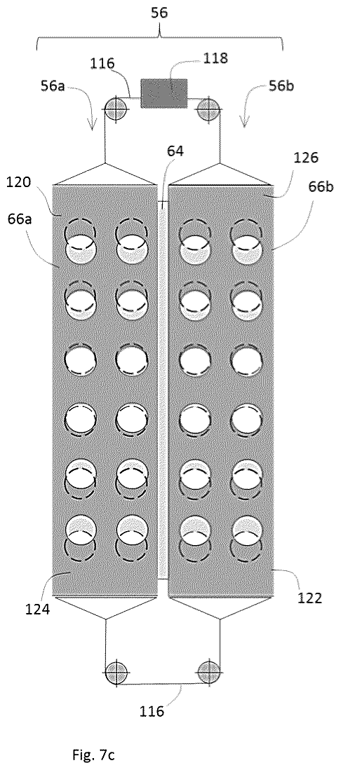

In another embodiment, for example as shown in FIGS. 7a to 7c, the first hole pattern 90 and the second hole pattern 92 may be dimensionally dissimilar along one of the axes, that is either the x-axis (denoted as X) or the y-axis (denoted as Y). As shown, the hole patterns differ along the y-axis (for clarity, the first and second hole patterns 90, 92, and the x-y axes are shown on FIG. 7a only). While similar to the embodiment detailed in FIGS. 5a to 5c, in this embodiment the upper perforated sheet 66 is provided in a split sheet format, that is with a first upper perforated sheet 66a, and a second upper perforated sheet 66b, therein establishing for the headliner 56 a first headliner area 56a, and a second headliner area 56b. The first and second upper perforated sheets 66a, 66b (collectively upper perforated sheets 66) are linked through a suitable linkage 116 and powered to move in opposing relationship to each other using a suitable actuator 118.

In this configuration, that is where the hole patterns differ along the y-axis, the plurality of air-passage openings 94 along the y-axis established by the overlap between the first and second hole patterns 90, 92 include a variance in sizing during motion of the upper perforated sheets 66 relative to the lower perforated sheet 64. For example, with reference to FIG. 7a, each of the first and second upper perforated sheets 66 are shown in a respective first position, where the overlap between the first and second hole patterns 90, 92 of the respective upper and lower perforated sheets 66, 64 define a plurality of fully opened air passage openings 94 as shown. More specifically, in this first position, the arrangement of the first upper perforated sheet 66a relative to the lower perforated sheet 64 presents a plurality of fully opened air passage openings 94 in a first zone 120, while the arrangement of the second upper perforated sheet 66b relative to the lower perforated sheet 64 presents a plurality of fully opened air passage openings 94 in a second diametrically opposed zone 122. At the same time, at each opposing end of the first and second headliner areas 56a, 56b, within the respective third and fourth zones 124, 126, the arrangement of the first and second hole patterns 90, 92 is such that no air passage openings 94 are established, therein establishing a ‘fully closed’ state in these zones 124, 126. Each row of overlapping (or partially overlapping) hole patterns extending from the first zone 120 to the third zone 124, and similarly from the second zone 122 to the fourth zone 126 become more progressively closed. Accordingly, in the first position as shown in FIG. 7a, the headliner assembly 56 permits for greatest HVAC air flow in the first and second zones 120, 122, with a progressively decreasing amount of air flow in the direction towards the third and fourth zones 124, 126, having regard to the split arrangement defined by the first and second upper perforated sheets 66a, 66b of the headliner assembly 56.

With reference to FIG. 7b, each of the first and second upper perforated sheets 66 are shown in a respective second position, where the overlap between the first and second hole patterns 90, 92 of the respective upper and lower perforated sheets 66, 64 define a plurality of fully opened air passage openings 94 as shown. More specifically, in this second position, the arrangement of the first upper perforated sheet 66a relative to the lower perforated sheet 64 presents a plurality of fully opened air passage openings 94 in the third zone 124, while the arrangement of the second upper perforated sheet 66b relative to the lower perforated sheet 64 presents a plurality of fully opened air passage openings 94 in a fourth diametrically opposed zone 126. At the same time, at each opposing end of the first and second headliner areas 56a, 56b, within the respective first and second zones 120, 122, the arrangement of the first and second hole patterns 90, 92 is such that no air passage openings 94 are established, therein establishing a ‘fully closed’ state in these zones 120, 122. Each row of overlapping (or partially overlapping) hole patterns extending from the third zone 124 to the first zone 120, and similarly from the fourth zone 126 to the second zone 122 become more progressively closed. Accordingly, in the second position as shown in FIG. 7b, the headliner assembly 56 permits for greatest HVAC air flow in the third and fourth zones 124, 126, with a progressively decreasing amount of air flow in the direction towards the first and second zones 120, 122, having regard to the split arrangement defined by the first and second upper perforated sheets 66a, 66b of the headliner assembly 56.

The transition from the first position to the second position has the effect of shifting the fully opened air passage openings 94 towards the opposing zone for each of the first and second headliner areas 56a, 56b. To demonstrate this, with reference to FIG. 7c, the headliner assembly 56 is shown with both the first and second upper perforated sheets 66 at an intermediate mid-point between the first and second positions. In this intermediate position, in both the first and second headliner areas 56a, 56b, the first and second hole patterns 90, 92 fully overlap in a mid region 130 of the headliner assembly 56, with the first, second, third and fourth zones 120, 122, 124, 126 including only partially opened air passage openings 94. Accordingly, in this arrangement, the headliner assembly 56 is said to be ‘fully opened’ in the mid-region 130.

### Actuation of the Upper Perforated Sheet

As shown above for each exemplary embodiment, the establishment of the air passage openings 94 is achieved through the spatial arrangement of the upper perforated sheet 66, relative to the lower perforated sheet 64, in particular the overlap between the first and second hole patterns 90, 92. It has also been demonstrated that the extent and/or placement of the airflow from the plenum outwardly into the passenger compartment can be controlled through a selected positioning of the moveable upper perforated sheet 66 relative to the lower perforated sheet 64, to achieve the air passage openings 94 in the desired area. While the positioning of the upper perforated sheet 66 may be manually actuated, it is preferred to implement a motorized actuator configured to be controlled through a suitable control mechanism, for example as provided as part of the vehicle HVAC system. A variety of actuator types may be implemented and will be selected in accordance with the required motion. For example, with respect to the first, second and fourth exemplary embodiments shown above (FIGS. 4a-4c, FIGS. 5a-5c, FIGS. 7a-7c), a linear actuator may be used to control the movement of the upper perforated sheet 66 between the first and second positions. For the third exemplary embodiment (FIGS. 6a-6d), the upper perforated sheet 66 undergoes a circular motion between the first to fourth positions. Accordingly, an actuator capable of a rotary motion would be used.

### Miscellaneous

In some embodiments of the headliner assembly 56, the plenum 86 below the vehicle roof 30 may require to be insulated, to prevent the influence of outside air temperatures impacting the HVAC air flowing therethough. For example, as shown in FIG. 2, the plenum 86 may include an insulative layer 140 affixed to the underside surface 26 of the roof 30.

In some embodiments, the stationary lower perforated sheet 64 may be fully formed with the plurality of holes including the aforementioned hole pattern. In this case, the lower perforated sheet 64 may be covered by a suitable porous aesthetic covering (not shown), to hide the holes, and prevent inadvertent obstruction during movement between the upper and lower perforated sheets. In an alternative embodiment, the stationary lower perforated sheet may be fully porous, and only a skin or supplemental layer may be provided at the interface between the upper and lower perforated sheets that include the aforementioned hole pattern. In this way, the lower perforated sheet may be formed in an aesthetically acceptable form, without the plurality of holes being visible to the passengers.

It will be appreciated that the implementation of the aforementioned headliner assembly may incorporate one or more of the embodiments noted above, as well as combinations thereof.

The arrangement of the hole pattern, in particular the size, quantity and density of the holes relative to the area of the sheet as detailed herein is merely exemplary for the purpose of explaining the technology. It will be appreciated the hole size, quantity and density relative to the sheet will be selected based on the air flow requirements for a particular installation.

Although the air distribution system described in the foregoing has been presented in the form of a headliner assembly, it will be appreciated that other configurations may be possible where an HVAC air distribution plenum can be established behind a panel. For example, similar air distribution systems may be incorporated into interior automotive structures such as interior trim panels, door panels, floor panels, forward and rearward seat panels, etc. It will be appreciated that any interior panel structure may be configured with the aforementioned first and second perforated sheets to enable control of air distribution from an air distribution plenum provided behind the panel, that is on the opposite side of the panel from the passenger compartment.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

What is claimed is:

1. A headliner air distribution system, the system comprising:
a headliner assembly having
a lower perforated sheet that is stationary,
an upper perforated sheet that is moveable relative to the first perforated sheet,
the headliner assembly being supported upon an underside surface of a vehicle roof by a pair of bracket rails,
wherein the arrangement of the bracket rails serves to place the headliner assembly in spaced-apart relationship relative to the underside surface of the vehicle roof, to establish a plenum for receiving HVAC air, and
wherein the spatial arrangement of the upper perforated sheet relative to the lower perforated sheet is used to control the passage of HVAC air from the plenum through the headliner assembly into the passenger compartment.

2. The headliner air distribution system according to claim 1, wherein the upper perforated sheet includes a first hole pattern and the lower perforated sheet includes a second hole pattern.

3. The headliner air distribution system according to claim 2, wherein the first and second hole patterns are each defined as having an x-axis dimension and a y-axis dimension, and wherein the first and second hole patterns are dimensionally equivalent with respect to the x-axis and y-axis of each.

4. The headliner air distribution system according to claim 2, wherein the first and second hole patterns are each defined as having an x-axis dimension and a y-axis dimension, and wherein the first and second hole patterns are dimensionally dissimilar along one axis with respect to the x-axis and y-axis of each.

5. The headliner air distribution system according to claim 2, wherein the first and second hole patterns are each defined as having an x-axis dimension and a y-axis dimension, and wherein the first and second hole patterns are dimensionally dissimilar along both axis with respect to the x-axis and y-axis of each.

6. The headliner air distribution system according to claim 1, wherein the upper perforated sheet is presented in the form of a split sheet, having a first upper perforated sheet and a second upper perforated sheet.

7. The headliner air distribution system according to claim 6, wherein the first upper perforated sheet and the second upper perforated sheet are linked through a suitable linkage 116 and move in opposing relationship to each other.

8. The headliner air distribution system according to claim 2, wherein the moveable upper perforated sheet is selectively moveable through a predetermined range of motion as determined by an actuator.

9. The headliner air distribution system according to claim 8, wherein the range of motion permits the upper perforated sheet to be selectively positioned relative to the stationary lower perforated sheet such that a plurality of air passage openings are established where the first and second hole patterns overlap.

10. The headliner air distribution system according to claim 9, wherein the plurality of air passage openings include both fully opened and partially opened air passage openings.
